(19) United States
(12) Patent Application Publication
(10) Pub. No.: US 2026/0319476 A1
(43) Pub. Date: Oct. 15, 2026

(54) Method for Outputting Prediction Data of a Prediction of At Least One Quality Parameter for At Least One Building Material Board

(71) Applicant: SIEMPELKAMP MASCHINEN-UND ANLAGENBAU GMBH, Krefeld (DE)

(72) Inventors: Bernd Russkamp, Willich (DE); Gregor Bernardy, Dahlem (DE)

(21) Appl. No.: 19/111,126

(22) PCT Filed: Sep. 7, 2023
(86) PCT No.: PCT/EP2023/074664

§ 371 Date: Mar. 12, 2025

(30) Foreign Application Priority Data
Sep. 13, 2022 (EP) 22195366.4

(51) Int. Cl. G05B 19/418

(52) U.S. Cl. CPC G05B 19/41875; G05B 2219/32194; G05B 2219/32201

(57) ABSTRACT

Among other things, a method including holding available a mathematical model for use in the production of at least one building material board is disclosed. The mathematical model is based on a number of training data records that corresponds to a minimum number or is greater than the minimum number. A training data record for a building material board type includes quality parameter data representing at least one value for at least one corresponding quality characteristic of a building material board sample of the building material board type, and process parameter data representing values for a plurality of process parameters of a production method for producing the building material board sample. he number of training data records includes at least one training data record for a building material board type that includes at least one building material board. The method further includes obtaining prediction data based on the mathematical model. The prediction data represents a prediction of at least one quality parameter for the at least one building material board; and outputting the prediction data.

### CROSS-REFERENCE TO RELATED APPLICATIONS

This application is the United States national phase of International Patent Application No. PCT/EP2023/074664 filed Sep. 7, 2023, and claims priority to European Patent Application No. 22195366.4 filed Sep. 13, 2022, the disclosures of which are hereby incorporated by reference in their entireties.

### BACKGROUND OF THE INVENTION

### Field of the Invention

Example embodiments of the invention relate to methods, devices, systems and computer programs in particular for outputting prediction data of a prediction of at least one quality parameter for at least one building material board.

### Description of Related Art

The continuous production of material and/or building material boards, for example wood-based panels, usually involves the use of complex production installations comprising a plurality of units or sections intended for respective production steps. For each such unit, a —usually large—number of process parameters can characterise the respective process conditions. For example, in the case of fibreboard production, the process parameters of residual water quantity, chip quantity, digester temperature, etc. are characteristic of process conditions of a process section of the defibration of a production installation for producing wood-based panels.

Such process parameters have an influence on the quality characteristics of building material boards produced under the corresponding production conditions, for example on transverse tensile strength, raw density, bending strength, etc.

Given the usually very large number of process parameters that can characterise the process conditions of a production installation for producing building material boards, it has proven advantageous to use mathematical models that describe a relationship between selected process parameters and resulting quality characteristics. Such models can help to calculate an influence of set and/or measured target or actual values of process parameters on expected quality characteristics and, in the case of a producing production installation, predict corresponding quality characteristics based on available target or actual values of process parameters. Corresponding prediction values can be displayed to an operator based on available target or actual values of process parameters, so that the production installation operator can react with corresponding settings of the production installation in order to set expected quality characteristics appropriately.

However, it has proven beneficial to generate mathematical models for predicting quality characteristics specific to a produced board type. Due to the relatively high number of building material board samples (also known as laboratory samples) required to produce a mathematical model for a building material board type, this can, however, lead to the fact that, in the case of building material board types whose share of total production is low, a corresponding mathematical model for such building material board types is only available after a comparatively long time when sufficient sample data records have been obtained.

It has also been found that, after a mathematical model has been generated for a type of building material board, predictions made by this mathematical model can deteriorate over time, for example depending on the season.

Against this background, it is a specific object of the present invention to provide methods, devices, systems and computer programs, in particular for outputting prediction data, which represent a prediction of at least one quality parameter of at least one building material board, even if a production share for the building material board type of the building material board is low in relation to an overall production. In addition, an object of the present invention is to provide, in particular for such building material board types, methods, devices, systems and computer programs, which output reliable prediction data. A further object of the present invention is to provide methods, devices, systems and computer programs that support a control of a production installation for the production of building material boards.

### SUMMARY OF THE INVENTION

According to an exemplary aspect of the invention, a method is disclosed which, for example, is carried out by at least one device or a system comprising at least two devices, the method comprising:
Holding available a mathematical model for use in the production of at least one building material board, wherein the mathematical model is based on a number of training data records that corresponds to a minimum number or is greater than the minimum number;
wherein a training data record for a building material board type comprises quality parameter data representing at least one value for at least one corresponding quality characteristic of a building material board sample of the building material board type, and process parameter data representing values for a plurality of process parameters of a production method for producing the building material board sample;
wherein the number of training data records comprises at least one training data record for a building material board type of the at least one building material board, the method further comprising:
Obtaining prediction data based on the mathematical model, wherein the prediction data represents a prediction of at least one quality parameter for the at least one building material board;
Outputting the prediction data.

According to this mentioned aspect of the invention, the following is further disclosed:
A computer program comprising program instructions which cause a processor to carry out and/or control the method according to the mentioned aspect of the invention when the computer program is executed by the processor. In this specification, a processor can be understood to mean, inter alia, control units, microprocessors, microcontrol units such as microcontrollers, Digital Signal Processors (DSPs), Application-Specific Integrated Circuits (ASICs) or Field Programmable Gate Arrays (FPGAs). Either all of the steps in the method can be controlled, or all of the steps in the method can be carried out, or one or more steps can be controlled and one or more steps carried out. The computer program can be at least in part software and/or firmware of a processor. It may be implemented at least partially in the same manner as hardware. The computer program can for example be stored on a machine-readable storage medium such as a magnetic, electric, optic and/or other type of storage medium. The storage medium can for example be part of a processor, for example a (non-volatile or volatile) program memory of the processor or a part of it. The storage medium can for example be a representational or physical storage medium.
A device or system comprising at least two devices, configured to carry out and/or control the method according to the mentioned aspect of the invention or comprising respective means for carrying out and/or controlling the steps of the method according to the mentioned aspect of the invention. Either all of the steps in the method can be controlled, or all of the steps in the method can be carried out, or one or more steps can be controlled and one or more steps carried out. One or more of the means can also be carried out and/or controlled by the same unit. For example, one or a plurality of the means can be formed by one or a plurality of processors. A device according to the mentioned aspect of the invention can, for example, be a control device connected to (at least parts of) a production installation for producing building material boards, in particular for controlling at least parts of a producing process of building material boards.
A device comprising at least one processor and at least one memory containing program code, wherein the memory and the program code are configured to cause a device with the at least one processor to perform and/or control at least the method according to the mentioned aspect of the invention. Either all of the steps in the method can be controlled, or all of the steps in the method can be carried out, or one or more steps can be controlled and one or more steps carried out.

In the following, properties of the mentioned aspect are described-in some cases by way of example.

In exemplary embodiments, the method according to the mentioned aspect of the invention can be carried out by at least one control device connected to a production installation for producing building material boards (directly and/or indirectly), in particular for controlling at least parts of a producing process for building material boards. In an exemplary embodiment, the method may be performed by a system comprising, for example, a plurality of control devices, each of the control devices performing (some or all) steps of the method. For example, a control device may comprise a processing system such as a single (or multiple) computer(s) provided on the production installation (and, for example, can receive sensor data and/or data from one or more measuring devices of the production installation via wired and/or wireless communication connections) and/or a mobile device such as a tablet computer, a smartphone, or the like, which is configured to perform at least parts of the method and which is connected, for example, to the processing plant and/or the production installation via a wireless communication connection. As disclosed further in the present specification, the method according to the mentioned aspect can be used in and/or to control at least parts of a production installation to production at least one building material board, or the method can at least support such control.

The production of building material boards, sometimes also simply referred to as “material boards” in specialist circles, takes place either in cycles or continuously. In the case of cycle-based production, the building material boards are produced as surface-shaped objects with finite dimensions in all three spatial directions, while the building material boards produced in a continuous process represent cut-to-lengths of a web product with finite dimensions only in two spatial directions. In this case, the operating method of the joining and/or compaction unit specifies whether the overall process is described as a cycle-based or continuous process, since in the case of a cycle-based production method, the process sections upstream of the compaction, such as scattering, are often also configured as continuous subprocesses. Since significant pressures are also used in the compression units or the combined joining and compression units in general in the production of building material boards, these units are usually referred to by a person skilled in the art as a “press part” with reference to an overall system. In the case of the production of building material boards within the meaning of this document, the working pressures here, depending on the material and size of the board to be produced, are usually in ranges between about 50 N/cm² and about 500 N/cm² and there advantageously between 100 N/cm² and 400 N/cm², although they can also be lower than 50 N/cm² in the area of the production of building material boards used for insulation, so-called insulation panels, at very low densities.

From both an economic point of view and with regard to their technical usability, at least one building material board with a layer having a natural-based fibre content is of particular importance among the building material boards. For the purposes of this document, natural-based fibres or fibre fractions are understood to mean fibres and fibre fractions that have a natural origin, i.e. originate from an annual plant or a perennial plant, regardless of whether the fibres or fibre fractions are pure fibres, e.g. for the production of MDF/HDF boards or their layer types or form components of chips, long chips or wafers that are traditionally used for the production of chipboard or OSB boards or their layer types. The term “wood particles”, which is also used hereinafter, therefore always includes at least natural-based fibres or fibre fractions.

Such building material boards are often also simply referred to by a person skilled in the art as “wooden building material boards”, even if they have one or more layers that are not based on a raw material obtained from a perennial plant. Even building material boards comprising only one or more layers consisting at least proportionally of fibres and/or fibre fractions derived from annual plants are usually referred to as wooden building material boards and very rarely very correctly as “bast or grass building material boards”.

Such wooden building material boards are produced in a wide variety of designs for different purposes. Chipboard, OSB boards and MDF (medium-density fibre boards) or HDF (high-density fibre boards), as well as hybrid boards constructed from individual layers of such compounds, are particularly widely used. The designation of the building material boards depends on the shape and size of the fibres or particles used for the panel or layer structure. A person skilled in the art speaks of a chipboard if it is produced from “fine” wood particles, or an OSB board if it is produced from “coarse” wood particles. “Fine” wood particles are generally understood by a person skilled in the art as particles whose maximum expansion in a spatial direction does not exceed 60 mm, most often these particles described as chips are even formed with a maximum expansion of a maximum of 25 mm or even 20 mm. “Coarse” wood particles are generally understood by a person skilled in the art as particles whose maximum expansion in a spatial direction is at least 60 mm, most often these particles described as long chips are even formed with a maximum expansion of no more than 60 mm to 185 mm, in particular from 80 mm to 140 mm.

MDF and HDF boards, or their individual layers, on the other hand, are formed from (medium-density or high-density pressed) fibres, which are usually obtained from the raw material by means of an intermediate chemical process, usually a type of cooking process.

Hybrid boards consist of several layers of different types and are often particularly suitable when the material board has to meet different requirements for its purpose.

Such building material boards are also referred to as wooden building material boards if they comprise individual layers that do not have any proportions of natural-based fibres and/or fibre proportions. These are usually laminated building material boards, i.e. wooden building material boards that are laminated on one or both sides on the outside. Plastics are usually used for lamination. Coated chipboards are particularly well-known here.

The aforementioned kinds and types of wooden building material boards are thus produced from wood particles (chips, long chips or fibres) of different shapes and sizes, wherein the wood particles are joined by stimulating their own adhesion mechanisms and adding adhesives (usually an adhesive) in the press part of a building material board production installation under the effect of pressure and temperature.

Recently, in addition to the wood materials that take many years to grow back, efforts have been made to use annual plants, especially grass-like plants, to produce building material boards. These annual plants have the great advantage of rapid growth. As a result, their use is particularly resource-conserving and fits better with the increasing awareness of the environment around the world. In addition, the increasing prosperity in many countries, such as Asia, requires covering a large demand for building material boards for residential construction, especially for interior fittings or furniture construction.

Since annual plants do not form a bark, their harvested products initially form a homogeneous raw material from a production point of view, the fibres of which can be obtained for the production of building material boards by means of a splitting process.

However, the processing of annual plants is much more complicated than wood particle-based building material boards. For example, the high precipitation of silicates that act abrasively on plant engineering in the production process is a major obstacle. This requires considerably increased effort, particularly with regard to plant construction, for example due to additional process steps, the reinforcement of certain plant parts and an increased need for spare parts. There is also a risk of production downtime.

Last but not least, the mechanical properties of board (layers) based on particles produced from annual plants also differ significantly from those of wood particle-based counterparts. Almost any complex dependency structures arise from the large number of process sections that build on each other, the variance of requirements for the individual process sections depending on the building material board types to be produced and their desired properties, as well as the parameters that affect the quality of the building material board to be produced within a process section.

A building material from which the said building material boards are produced comprises, in exemplary embodiments, a wood material, an insulation material, and/or one or more raw materials such as rice straw, Bagasse, bamboo, hemp, oil palm. Examples of building material boards include chipboard, coarse chipboard or OSB boards and/or MDF boards.

For the purposes of the present disclosure, the term building material boards is understood to mean boards that, for example, contain at least a large proportion (for example, more than 25 wt %) of at least one of the said building materials, in the case of wooden building material boards, for example at least a large proportion (for example more than 50 wt %, in particular more than 75 wt %, for example at least 80 wt %) of cellulose-containing, for example lignocellulose-containing, material, such as wood chips. Such building material boards may comprise further materials such as plastic materials, which may for example be present at least partially in particle and/or fibre form.

A production installation for producing building material boards can thus in particular comprise a production installation for producing wooden building material boards (or wood-substitute building material boards). Such production installations usually comprise several production units or sections, for example a section (for example, a bunker) for storage, debarking and/or chopping, a section for chip washing, a defibration and/or machining and glueing section, a fibre and/or chip drying section, a mat forming section, and/or a hot pressing section.

Production conditions, in particular for individual sections and/or units of the production installation, can be characterised by corresponding process parameters. It is understood here that process parameters within the meaning of the present disclosure correspond in particular to actual values and/or target values. Thus, in exemplary embodiments, the production installation has at least one sensor and/or at least one measuring device. For example, the production installation may have one or more pressure sensors, temperature sensors and/or humidity sensors. The production installation may further comprise, for example, one or more measuring devices for measuring properties of the building material boards, for example for measuring properties of wood chips. However, it is understood that the present disclosure is not limited to such sensors and/or measuring devices. In particular, the production installation has at least one production section which has at least one sensor. For example, a press section can have a pressure sensor, wherein corresponding pressure measurement values can correspond to the pressure process parameter. Alternatively or additionally, a set pressure target value at the corresponding press section can correspond to the pressure process parameter.

In other words, the method is carried out in an exemplary embodiment by a control device of a production installation or by a system comprising such a control device, wherein the production installation has at least one sensor and/or at least one measuring device, which is configured to output at least one sensor measured value and/or one measured value of at least one measuring device as a target or actual value of a corresponding process parameter, and which characterises a corresponding process condition during the production of the building material board by the production installation.

Example process parameters not limiting the present disclosure, in particular of the section for defibration and glueing, can include a residual water quantity, a steam injection of a cooker, a fill level of the cooker, a cooker temperature, a steam pressure of the cooker, a cooking time with the cooker, a quantity of wood chips, a paraffin injection, etc. Example process parameters not limiting the present disclosure, in particular of the section for mat forming, can include a fibre discharge quantity, a spreading height, a mould belt speed, an area weight of the mat, a mat moisture, a spreading width, a pre-press pressure, a pre-press distance, an edging width, a mat density, a spray water quantity, and so on. It is understood that separate process parameters exist for further units and/or sections of a production installation, which characterise the corresponding production conditions of these further units and/or sections.

The production conditions that prevail/are set in a production installation for/during the production of a building material board have at least a partial influence on the properties of the produced building material board. Such properties of a building material board can be characterised in particular by quality characteristics or quality parameters. For the purposes of the present disclosure, quality characteristics, or quality parameters, in particular a transverse tensile strength, a raw density, a bending strength and/or a thickness swelling may comprise, wherein these examples are not to be understood as limiting. For example, additional quality characteristics or quality parameters can be provided.

A production installation can have suitable sensors and/or measuring devices at different production sections so that production conditions can be recorded at the different production sections during the production of a building material board and can be assigned to a produced building material board. In this way, sensor data and/or measurement data of a measuring device with a corresponding timestamp can be assigned to a produced building material board as a data record. Such temporally assigned data records/data vectors contain the process conditions or process states under which the corresponding building material board was generated.

Typically, produced building material boards are ejected at regular intervals, after a completed production process of the produced building material boards or parts thereof in order to measure corresponding quality characteristics or quality parameters for these ejected building material boards, for example in a laboratory or by a test robot. In this way, sample data records can be obtained that include quality parameter data and corresponding process parameter data for a building material board sample (whole flap or part thereof) of a corresponding building material board type. These sample data records thus provide an actual correlation between set/prevailing process conditions at corresponding sections of the production installation, which are represented by the time-assigned process parameter data, and resulting quality characteristics of the building material board produced under these process conditions. Based on this information contained therein, the sample data records can be used as training data records for a mathematical model for use in the production of building material boards of the corresponding building material board type, and are referred to hereinafter as training data records.

Thus, according to the mentioned aspect of the present invention, a training data record for a building material board type comprises quality parameter data that represents at least one value (e.g. a measured value measured for a corresponding building material board sample in a laboratory) for at least one corresponding quality characteristic of a building material board sample of the building material board type, and process parameter data that represents the values (or process parameter values, e.g. one or more target or actual values for each of a process parameter, e.g. obtained by a corresponding sensor, a corresponding measuring device, and/or by a corresponding adjustment device of the production installation) for a plurality of process parameters of a production method for producing the building material board sample.

In this case, the process parameter data in exemplary embodiments comprise respective timestamps or respective timestamps are assigned to the process parameter data (for example stored in assignment with the process parameter data), which are assigned to a corresponding process parameter. In other words, the process parameters may correspond to the majority of process parameters in exemplary embodiments of temporally assigned process parameter values comprising a timestamp. The timestamp corresponds to the time for which a process parameter value characterises a process condition that existed during the production of a produced building material board.

In exemplary embodiments, the method comprises a step of holding available (e.g. storing) at least one training data record on a storage medium connected to the production installation or provided for a connection to the production installation, and to which the at least one control device can access.

Based on the training data records, it is possible to model the production process of a building material board type for a production installation. In exemplary embodiments, it may, for example, be possible to assign corresponding coefficients or weights of a mathematical model to the process parameters in particular for several training data records, and to determine these in corresponding equation systems of the mathematical model based on the measured quality characteristics. This can be done successively for ever more training data records (for example, always when new sample data records are received as training data records from laboratory measurements during the course of production), so that the mathematical model can be “learned” with further training data records and thus “trained”. Accordingly, as mentioned, sample data records used to train a mathematical model (on which the mathematical model is based) are referred to herein as training data records.

As mentioned, the method according to the mentioned aspect of the present invention comprises holding available a mathematical model for use in the production of at least one building material board (for example, a series of several building material board of a corresponding building material board type), wherein the mathematical model is based on a number of training data records, in particular for the building material board type of the building material board being produced and/or part of the series of building material boards, equal to a minimum quantity or greater than this minimum quantity.

In exemplary embodiments, a mathematical model comprises a set of model coefficients for one or more mathematical equations. In particular, in exemplary embodiments, a mathematical model comprises a set of model coefficients for one or more mathematical equations, wherein the one or more mathematical equations with the model coefficients are provided such that the one or more mathematical equations, based on an input of values from at least one process parameter data record, comprising values for process parameters with associated timestamp, can output a value (an expected value) for at least one quality parameter.

In other words, during the production of building material boards, for example, set and/or measured target and/or actual values of process parameters of the production installation can be transmitted to the at least one control device, which is connected to the production installation via suitable communication connections for this purpose. With the values of the process parameters thus obtained, the at least one control device can calculate prediction values for quality characteristics by means of the mathematical model that can be expected for the building material boards currently produced based on the set and/or measured target and/or actual values. Accordingly, the method according to the mentioned aspect comprises obtaining prediction data based on the mathematical model, wherein the prediction data represents a prediction of at least one quality parameter for which at least one building material board (the building material board that is produced and/or is part of the series of building material boards that are produced).

Herein, in an exemplary embodiment, obtaining the prediction data comprises computing the prediction data by and/or at the at least one control device, for example by one or more processors and/or by one or more data processing systems. Alternatively or additionally, receiving the prediction data in an exemplary embodiment comprises receiving the prediction data by the at least one control device, for example from a device connected to the control device at least via a communication connection.

These prediction values can be displayed to an operator of the production installation so that he/she can influence the expected quality characteristics by adjusting process parameters if necessary. Additionally or alternatively, control signals can be generated based on the prediction data, based on which the at least one control device can readjust process parameters for producing the at least one building material board accordingly.

Thus, in an exemplary embodiment, the provision of the mathematical model for use in the production of at least one building material board, wherein the mathematical model is based on a minimum number of training data records, comprises storing on a storage medium connected to the at least one production installation and/or to which the at least one production installation can access, selected from at least one of:
at least one model coefficient for one or more mathematical equations;
at least one training data record for training and/or generating the mathematical model;
data, for example program data, representing the mathematical equations.

Herein, in an exemplary embodiment, the training data records (of the minimum number of training data records) on which the mathematical model is based comprise training data records that were used to train or generate the mathematical model for use in the production of the at least one building material board.

In this case, a mathematical model can be generated for use in the production of at least one building material board based on a number of training data records available for the building material board type to be produced (stored on a storage medium connected to the at least one control device), wherein the mathematical model thus generated is then used for predictions of at least one quality parameter of the building material boards to be produced and/or in production. In particular, if one or more building material boards are rejected from ongoing production, measured in the laboratory, and thus new sample data records become available as training data records, the mathematical model can be updated based on the new training data records. For this purpose, the mathematical model can be generated based on the previously existing training data records and the new training data records, which is also understood within the present disclosure as training the mathematical model based on the new training data records.

Thus, the method in an exemplary embodiment comprises:
Generating and/or training the mathematical model for use in the production of at least one building material board based on the number of training data records equal to or greater than the minimum number.

In exemplary embodiments, the mathematical model comprises a statistical model or corresponds to a statistical model. In particular, in an exemplary embodiment, the mathematical model is based on a model for interdependent simultaneous stochastic linear equations. It has been shown that, for example, regression models for interdependent systems of simultaneous (linear) stochastic equations can be suitable for modelling the production processes for building material boards. In particular, the processes in the wood materials industry can be regarded as interdependent and simultaneous, since several product properties occur simultaneously and not independently of each other and there are mutual dependencies of the influencing variables or process parameters. The model equations can be described as linear because the model coefficients enter linearly.

However, it is understood that the present disclosure is not limited to such linear systems. For example, process parameters can also flow in with a square, cubic or exponential (or other) weight.

Thus, the mathematical model in exemplary embodiments comprises a simultaneous equation model, in particular a mathematical model based on the three-stage least squares (“3SLS”) method. In exemplary embodiments, the mathematical model further comprises a mathematical model based on the two-stage least squares (“2SLS”) method, a mathematical model based on the partial least squares (PLS), and/or a linear regression model.

As mentioned, in an exemplary embodiment, the training data records for access by the at least one control device are stored (are kept available) on a storage unit which the at least one control device can access. In exemplary embodiments, the method according to the mentioned aspect comprises holding available/storing the plurality of training data records, for example on a storage medium to which the at least one control device is connected and/or which the at least one control device can access. In exemplary embodiments, a value of a process parameter represents a corresponding process condition of a production method for producing a building material board.

It is understood that data within the meaning of the present disclosure, for example the quality parameter data, the process parameter data and/or data, which are disclosed hereinafter, comprise any type of information that is transmitted from a processing device, such as from the at least one control device, a processor, a system, can be read and/or processed by one or more processors, and/or one or more computers, and which can in particular be stored for this purpose on a storage medium which is suitably connected directly and/or indirectly (e.g. directly, wired or wirelessly) to the at least one control device, the processor, the system of one or more processors, and/or to the one or more computers.

As mentioned, the mathematical model is based on a number of training data records that equals or exceeds a minimum number. In this case, the minimum number can correspond to a number of training data records that is sufficient so that training/generating the mathematical model with this number of training data records results in a mathematical model that can output prediction values for at least one quality parameter, the quality of which meets a predetermined quality criterion. To check whether predicted values by a mathematical model meet the predetermined quality criterion, for example, a value of a quality criterion predicted based on process parameter values of a sample data record can be compared with the actually measured value of the quality criterion from the sample data record. For example, the quality criterion can be met if an absolute value of a difference between the predicted value and the actual measured value is less than or equal to a predetermined value.

In other words, in an exemplary embodiment, the minimum number of the number of training data records for which a mathematical model trained and/or generated based on this number of training data records can output a prediction value for at least one quality criterion, wherein a quality of the prediction value meets a predetermined quality criterion. In an exemplary embodiment, the minimum number of training data records is between 20 and 100, between 30 and 80, between 35 and 70, and/or between 40 and 60 for the (one or more) quality parameters for which prediction data are obtained based on the mathematical model.

The minimum number can be fixed, for example for a mathematical model for a building material board type, or can be set flexibly, for example by user input. In particular, the latter case offers an operator the possibility to set the minimum number flexibly. In both cases, a value for the minimum number for access by the at least one control device may be stored on a storage medium connected to the at least one control device and/or which the at least one control device can access. In other words, the method in an exemplary embodiment comprises:
Obtaining at least one piece of information representing a value of the minimum number, the receiving comprising at least one of:
Obtaining (e.g. receiving) the at least one piece of information based on an input via a user interface connected to the at least one device (of the at least one control unit);
Accessing a storage unit connected to the at least one device (of the at least one control unit) in order to obtain the at least one piece of information;

According to the mentioned aspect of the present invention, the number of training data records on which the mathematical model is based comprises at least one training data record for a (the) building material board type of which at least one building material board (the building material board that is produced and/or is part of the series of building material boards that are produced).

For building material board types that are produced frequently and/or with a high number, the proportion of which of a total production quantity is therefore correspondingly high, this minimum number can be achieved relatively quickly under certain circumstances by training/generating the mathematical model based on training data records for only one building material board type, for the building material board type of the building material boards that are produced frequently and/or with a high number. For such building material board types, due to the high production quantity and a correspondingly high possible number of building material board samples that can be given to a laboratory for measurement, sample data records with a relatively high frequency can be generated, whereby the minimum number can be reached relatively quickly.

Accordingly, the present disclosure comprises an exemplary embodiment according to which the number of training data records on which the mathematical model is based comprises training data record only for a (the) building material board type of which at least one building material board (which is produced and/or is part of the series of building material boards that are produced) is produced.

It is understood here that, as long as the minimum number for a building material board type has not yet been reached, and a mathematical model for this building material board type cannot yet be used in the production of the corresponding building material boards for a prediction of expected quality parameters, the production of the building material board type can be carried out without such prediction values, based on experience values of the operators of the production installation. However, it has emerged that a control of the production installation based on prediction values by the mathematical model (for example by an operator of the installation based on displayed prediction values and/or by direct control of the installation based on control data generated based on the prediction data and used for direct/automatic/electronic control of at least one part of the production installation) leads to the production of building material boards with increased efficiency.

It is therefore desirable to be able to use a mathematical model also for the production of building material boards of a building material board type for which, for example, the minimum number of training data records has not yet been reached due to a lower production share of the total production quantity of the production installation. Here it has been found that it is possible to generate/train a mathematical model based on training data records that are only partly for the building material board type in question and partly for another building material board type. In other words, in an exemplary embodiment, the number of training data records comprises the at least one training data record for the building material board type of the at least one building material board, and at least one training data record for at least one other building material board type.

It has been found that this is particularly possible if the building material board type of the low production share is grouped with a building material board type of a higher production share, i.e. if the number of training data records is composed of a number of training data records for the building material board type of the low production share and a number of training data records for the building material board type of the higher production share. However, grouping is also possible, and often makes sense if the production shares are approximately the same, for example, do not differ by more than 10%. Thus, in an exemplary embodiment, a production share of a total production quantity of building material boards of the building material board type of the at least one building material board is approximately equal to or less than a production share of building material boards of the other building material board type. In other words, the mathematical model in an exemplary embodiment is based on a number of training data records for the building material board type of the at least one building material board (which is produced and/or is part of the series of building material board that are produced), and at least on a number of training data records for the other building material board type, wherein the number of training data records for the building material board type of the at least one building material board (which is produced and/or the part of the series of building material boards that are produced) is less than the minimum number and/or less than the number of building material boards of the other building material board type. In this case, the total number of training data records is equal to or greater than the minimum number, i.e. the number of training data records for the building material board type of at least one building material board (which is produced and/or is part of the series of building material boards that are produced) and the number of training data records for the other building material board type result in a total number that is equal to or greater than the minimum number.

It has been found that for a board type for which there are not yet sufficient training data records available (the number of which is less than the minimum number), grouping with a board type for which there are sufficient training data records available (the number of which is equal to or greater than the minimum number) can be advantageous, in particular if the board types are similar at least in one property. Board types can be characterised and/or classified in particular on the basis of their properties, wherein in exemplary embodiments a property of a building material board type is selected from at least:
Building material board thickness;
Building material board width;
Building material board density;
Type of bonding of the building material board;
At least one material of the building material board, in particular at least one type of glue and/or one type of wood material.

A building material board can be characterised by one or more of these properties, wherein corresponding parameter values for one or more of these properties are held in exemplary embodiments for access by the at least one control device, for example stored on a storage medium which is connected to the at least one control device and/or which the at least one control device can access.

In an exemplary embodiment, the building material board types are then similar in at least one property if, for the building material board types, at least one parameter value representing at least one property is similar. This may be the case if a difference between parameter values for the two building material boards with regard to the at least one property is not above a maximum value, for example specified, for example defined by an operator. Thus, for the building material board type of the at least one building material board (which is produced and/or is part of the series of building material boards that are produced) and for the at least one other building material board type, a value of a difference between at least one parameter value that characterises a property of the building material board type of the at least one building material board (which is produced and/or is part of the series of building material boards that are produced), and at least a corresponding parameter value that characterises the corresponding property of the at least one other building material board type, is equal to a maximum value, or falls below the same. In this case, in an exemplary embodiment, the value comprises an absolute value or amount/absolute amount, wherein other values that can indicate the distance of two parameters are also conceivable.

Because, as mentioned, it is advantageous to use a mathematical model based on a type of building material board to be produced, it is advantageous if a building material board type, for example at the start of production of a series of building material boards of a type, for which at least one control device can be set. Accordingly, the method in an exemplary embodiment comprises:
Obtaining (e.g. receiving) information representing the building material board type of the at least one building material board (which is produced and/or is part of the series of building material boards that are produced).

It is understood that information within the meaning of the present disclosure, for example the information representing the building material board type of the at least one building material board and/or the information, which are disclosed hereinafter, comprise any type of computer-readable and/or electronically-readable information transmitted by a processing device, such as from the at least one control device, a processor, a system of one or more processors, and/or one or more computers can be read and/or processed.

The information representing the building material board type of the at least one building material board (which is produced and/or is part of the series of building material boards that are produced) will be obtained in an exemplary embodiment based on an input via a user interface. In exemplary embodiments, the user interface comprises:
at least one keyboard and at least one screen,
one or more touchscreens,
one or more means of voice input, and/or
a mobile device connected to the production installation, for example a smartphone, a tablet computer, a laptop.

In exemplary embodiments, the user interface is connected directly—wired and/or wirelessly—to the production installation and/or to the at least one control device and/or, for example, via an Internet connection. In exemplary embodiments, a user interface comprises a display device such as one or more screens and an input device such as one or more keyboards, a computer mouse, and/or an input/output device such as one or more touchscreens. In exemplary embodiments, the at least one control device comprises a mobile device such as one or more smartphones, one or more tablet computers and/or one or more laptops, wherein a user interface in particular in these embodiments comprises one or more touchscreens of a mobile device.

Based on the data representing the building material board type of the at least one building material board, the at least one control device can check whether a mathematical model exists for the building material board type to be produced (e.g. on one with which at least one control device is stored) that is based on sufficient training sets (only for the building material board type to be produced or in grouping with another building material board type).

Accordingly, the method in an exemplary embodiment comprises:
Determining, based on the information received representing the building material board type of the at least one building material board, whether a mathematical model for use in producing the at least one building material board is available that is based on a number of training data records equal to or greater than the minimum number.

It is understood here that determining whether a mathematical model exists comprises determining whether such a mathematical model (based on sufficient training data records) is stored, for example, on a storage unit which is connected to the at least one control device and/or which the at least one control device can access. It is further understood that connections in accordance with the present disclosure comprise in particular direct or indirect wired communication connections (e.g. LAN connections), and/or direct or indirect wireless communication connections comprising radio connections such as Bluetooth, NFC, WLAN, 4G or 5G and/or communication connections over the Internet. In this case, indirect connections can comprise one or more connections via one or more intermediate nodes.

It is further understood here that storing a mathematical model in exemplary embodiments comprises storing at least one selected from:
at least one model coefficient for one or more mathematical equations of the mathematical model;
at least one training data record, for training and/or generating the mathematical model;
data, for example program data, representing the mathematical equations.

If, based on the information received, which represents the building material board type of the at least one building material board, it is determined that a mathematical model for use in the production of the at least one building material board is available based on a number of training data records equal to or greater than the minimum number, the method further comprises in an exemplary embodiment:
Holding available the mathematical model for use in producing the at least one building material board if it is (has been) determined that the mathematical model is available for use in producing the at least one building material board.

Otherwise, in an exemplary embodiment, no mathematical model is used in the production of the at least one building material board.

In other words, in this exemplary embodiment, the step of holding available a mathematical model for use in the production of at least one building material board comprises holding available the mathematical model for use in the production of the at least one building material board if it is (has been) determined that the mathematical model is available for use in the production of the at least one building material board.

As mentioned, a mathematical model provided for a type of building material board may, over time, produce prediction values of reduced quality. Such changes may be the result of, for example, changing seasons, changes to parts and/or materials of the production installation, etc. However, it has proven advantageous that an influence of such rather long-term changes can be mitigated by older training data records no longer being used to generate/train a mathematical model for use in the production of the at least one building material board.

In particular, for this purpose, a training data record in an exemplary embodiment comprises a timestamp and/or there is an assignment between the timestamp and the training data record in this exemplary embodiment. The timestamp represents a time at which the building material board sample was produced. For example, this point in time may be the point in time at which the building material board sample was cut off from a longer, in-production building material board strip and/or the point in time at which the building material board sample was rejected for measurement in the laboratory. It is understood here that the timestamp represents such a time, but it does not depend on the exact numerical value, for example. For example, there may in particular be a fixed time difference between the actual time of channelling out and/or sawing off the building material board sample and the time value indicated by the timestamp. Such a timestamp allows training data records to be discarded if they are no longer up to date.

In an exemplary embodiment, the method further comprises
Receiving information that represents statement that at least one training data record on which the mathematical model is based comprises a timestamp or is assigned to it that represents a time that is before a predetermined time interval.

In this case, this information can be obtained automatically from the at least one control device and/or can be obtained based on a user input. Thus, in an exemplary embodiment, obtaining the information that represents a statement that at least one training data record on which the mathematical model is based comprises or is assigned to a timestamp that represents a time that lies before a predetermined time interval comprises at least one of:
Obtaining the information representing the statement that at least one training data record on which the mathematical model is based comprises or is associated with a timestamp representing a time that is prior to a predetermined time interval based on an input via a user interface;
Determining whether at least one training data record on which the mathematical model is based comprises a timestamp or is assigned to it that represents a time that is before a predetermined time interval.

Accordingly, the method in an exemplary embodiment further comprises:
Discarding of at least one training data record from the number of training data records on which the mathematical model is based, if the at least one training data record comprises a timestamp and/or is assigned to this timestamp that represents a time that is before a predetermined time interval.

In an exemplary embodiment, the predetermined time interval comprises a time interval before the start of an embodiment of the method and/or a production of the at least one building material board. In this case, the time interval is determined in an exemplary embodiment in relation to the start of the execution of the method and/or to the start of the production of the at least one building material board. The time interval can, for example, be a number of years (for example 2 years) before the day on which the production of the at least one building material board is started using the mathematical model. In an exemplary embodiment, the predetermined time interval thus comprises one or more days, one or more months and/or one or more years prior to the start of the production of the at least one building material board using the mathematical model.

In an exemplary embodiment, the method further comprises:
Generating or training the mathematical model for use in producing the at least one building material board based on a number of training data records that does not contain the discarded training data record.

In one exemplary embodiment, the provision of the mathematical model for use in the production of the at least one building material board comprises the provision of the mathematical model for use in the production of the at least one building material board, wherein the mathematical model is based on the number of training data records that do not contain the discarded training data record.

In this way, it is advantageously possible in that older training data records are no longer used for training and/or generating the mathematical model, whereby the mathematical model is kept up to date, which in turn mitigates long-term negative influences, for example due to seasons. In this way, the mathematical model can output more reliable prediction data in particular.

As mentioned, a mathematical model for use in the production of at least one building material board can be generated based on a number of training data records existing for the building material board type to be produced (stored on a storage medium connected to the at least one control device). In particular, if one or more building material boards are rejected from ongoing production, measured in the laboratory, and thus new sample data records become available as training data records, the mathematical model can be updated based on the new training data records. Similarly, the mathematical model can, for example, be updated before the start of production of the at least one building material board, i.e. for example, before the start of production of a series of building material boards of a building material board type.

For such update processes, the method in an exemplary embodiment comprises:
Receiving information that represents a statement that at least one training data record is present (e.g. stored on a storage medium connected to the at least one control device and/or to which the at least one control device can access), which is not comprised by the number of training data records on which the mathematical model is based.

In other words, the at least one control device configured in this embodiment is to receive information that, in addition to the training data records on which the mathematical model is based, further training data records are available. In this case, the step of obtaining the information that at least one training data record exists, which is not comprised by the number of training data records on which the mathematical model is based, is carried out in an exemplary embodiment before and/or during a production of the at least one building material board using the mathematical model.

If the information is received that at least one training data record exists that is not comprised by the number of training data records on which the mathematical model is based, the method comprises in an exemplary embodiment:
Training and/or generating the mathematical model based on the training data records comprised by the number of training data records and based on the at least one training data record not comprised by the number of training data records.

In this case, the mathematical model can be generated based on the previously existing training data records and new training data records not yet included in the mathematical model. This can take place before a start of a production of the at least one building material board and/or during the production (during the production process) of the at least one building material board. Within the framework of the present disclosure, generating the mathematical model based on previously existing training data records and newly added training data records also means training the mathematical model based on the new training data records.

The information that at least one training data record exists, which is not comprised by the number of training data records on which the mathematical model is based, can take place via an input of an operator of the production installation via the said user interface and/or can be automatically recorded by the at least one control device. Accordingly, the method in an exemplary embodiment comprises:
Receiving the information that represents a statement that at least one training data record exists that is not included in the number of training data records on which the mathematical model is based based on an input via a user interface.

Alternatively or additionally, obtaining the information that represents the statement that at least one training data record exists that is not comprised by the number of training data records on which the mathematical model is based comprises:
Determining whether at least one training data record exists that is not included in the number of training data records on which the mathematical model is based.

In this embodiment, training and/or generating the mathematical model based on the training data records comprised by the number of training data records and based on the at least one training data record not comprised by the number of training data records comprises:
Training and/or generating the mathematical model based on the training data records comprised by the number of training data records and based on the at least one training data record not comprised by the number of training data records, if it is determined that at least one training data record exists that is not included in the number of training data records on which the mathematical model is based.

In this exemplary embodiment, the method further comprises obtaining (e.g. calculating by the at least one control device) prediction data based on the mathematical model, wherein the mathematical model is based on the training data records comprised by the number of training data records, and based on the at least one training data record not comprised by the number of training data records, wherein the prediction data represents a prediction of at least one quality parameter for the at least one building material board (the building material board that is produced and/or the part of the series of building material boards that are produced), and an output of the prediction data.

The described update process based on the new training data records makes it possible to keep the model up to date and, in particular, to adapt it better and better to this type of building material board within a production process of building material boards of a building material board type. This is particularly advantageous in cases where a mathematical model is initially based on a grouping of training data records for the building material board type to be produced with training data records for another building material board type. In such cases, continuous updating of the mathematical model based on new training data records obtained during the production process may allow sufficient training data records to be available for the type of building material board to be produced after a certain production time (possibly after some production cycles), so that predictions for this type of building material board are possible with a mathematical model, which is only based on training data records for this type of building material board to be produced.

A production installation for the production of building material boards typically comprises a plurality of production sections and/or units. Production conditions to which an intermediate product is exposed during the production of the building material board at/within such a production section and/or at/within such a production unit can in turn be determined by a plurality of process parameters. Since, for example, corresponding sensors and/or measuring devices of a production installation determine corresponding target and actual values for respective process parameters during production, and these are stored in the sample data records at least for respective building material board samples (for which quality characteristics are measured in the laboratory), the sample data records can contain target and actual values for a large number (e.g. for up to or even more than 3500 in a typical production installation) of process parameters.

However, since not all process parameters need to have an equally great influence on the resulting quality characteristics of a produced building material board, it has proved advantageous to make a preselection of (typically a few hundred, for example 250 to 500) process parameters (determining a group of process parameters) that is considered when adjusting and/or generating the mathematical model (e.g. by the at least one control device). This preselection is provided to the at least one control device in an exemplary embodiment in the form of process parameter selection information. In particular, this allows checking and, if necessary, minimising the computational effort used for adapting and/or generating the mathematical model. It has also proven to be advantageous to output the mathematical model of predicted values for a preselection of quality parameters.

Accordingly, the provision of the mathematical model for use in the production of the building material board in an exemplary embodiment comprises:
Obtaining process parameter selection information representing a selection of process parameters of the production method for producing the at least one building material board and/or information for which a value for the at least one building material board (the building material board that is produced and/or the part of the series of building material boards that are produced) is to be predicted by the mathematical model;
Generating the mathematical model based on the selection of process parameters and/or for the at least one selected quality parameter.

In this case, the process parameter selection information and/or the information representing the at least one selected quality parameter from which at least one control device can be queried from a database, for example via an Internet connection, and/or based on information stored locally, for example on the storage unit connected to the at least one control device. Alternatively or additionally, this information can be obtained via a user input using the specified user interface. In other words, in an exemplary embodiment, obtaining the process parameter selection information and/or the information representing the at least one selected quality parameter comprises at least one of:
Obtaining the process parameter selection information and/or the information representing the at least one selected quality parameter based on an input via a (the) user interface;
Obtaining the process parameter selection information and/or the information representing the at least one selected quality parameter based on a query of a database and/or a storage unit to which the at least one control device can access.

In an exemplary embodiment, the method is carried out by at least one control device of a production installation for producing building material boards or by a system comprising at least one such control device. In this case, the production installation comprises at least one sensor and/or one measuring device, which is configured to output at least one sensor measured value and/or one measured value of the measuring device as a target or actual value of a corresponding process parameter, which characterises a corresponding process condition during the production of the building material board by the production installation, wherein obtaining the prediction data based on the mathematical model further comprises:
Obtaining the prediction data based on the mathematical model and based on at least one sensor measurement value and/or at least one measurement value of the measuring device.

In an exemplary embodiment, obtaining the prediction data comprises using the at least one received sensor measurement value and/or the at least one received measurement value of the measuring device as input variable(s) for the mathematical model, and calculating the prediction data by means of the mathematical model based on the input variable(s). In this case, sensor measurement values and/or measurement values of the measuring device can be received by the at least one control device for example via one or more corresponding communication connections with at least one corresponding sensor and/or with at least one corresponding measuring device of the production installation. Thus, the method in an exemplary embodiment comprises:
Receiving the at least one sensor measured value and/or the at least one measured value of the measuring device via a communication connection from at least one sensor of a production installation for producing the at least one building material board and/or from at least one measuring device of the production installation for producing the at least one building material board.

As mentioned, the method according to the mentioned aspect involves an output of the prediction data. As mentioned, the prediction data can be used to control a production installation for producing the at least one building material board and/or at least support controlling the production installation. In an exemplary embodiment, the method thus further comprises:
Controlling at least one unit and/or a section of a production installation for producing the at least one building material board based on the output prediction data. It is understood here that in exemplary embodiments, a control comprises at least one of:
A direct control of the at least one unit and/or the at least one section based on corresponding control signals generated by the at least one control device based on the output prediction data,
A control of the at least one unit and/or the at least one section by an operator of the system based on an indication (e.g. a visual indication by a display device) of the prediction of the at least one quality parameter based on the prediction data output.

An output of the prediction data can thus comprise an internal output of this data, for example within the at least one control device, for example for further processing of the prediction data by the at least one control device. An output of the prediction data can further comprise an output of the prediction data for further processing by an external device (from the at least one control device). For example, the output prediction data can be converted in the control device or in another data processing device into said control signals and/or into display data that can be used by said display device (e.g. from a screen connected to the control device) to display a representation.

Thus, the method in an exemplary embodiment may comprise:
Triggering, based on the prediction data output, a display of a representation of the prediction of the at least one quality parameter for the at least one building material board (the building material board that is produced and/or the part of the series of building material boards that are produced) based on the prediction data; and/or
Generating, based on the output prediction data, control signals for controlling at least one unit and/or a section of the production installation and/or for setting at least one process parameter of the production installation during a production of the at least one building material board.

In this case, a representation can for example comprise a graphical representation of the prediction data (for example a real-time representation) in the form of a data value-time curve on a screen, wherein the screen as a display device can be connected directly or indirectly to the control device and/or the production installation. Such a display of the prediction data can allow a user to set the production installation (e.g. in real time) in response to the displayed prediction values of the quality characteristics.

In alternative or additional embodiments, the at least one control signal generated based on the prediction data is used to directly control at least one component of the production installation, for example using a feedback loop-operated control electronics.

### BRIEF DESCRIPTION OF THE DRAWINGS

Further advantageous exemplary embodiments of the invention can be drawn from the following detailed description of a number of exemplary embodiments of the invention, in particular in combination with the drawings. However, the figures enclosed with the application are only intended to be used for illustration purposes and not to limit the scope of protection of the invention. The enclosed drawings are not necessarily true to scale and are simply intended to reflect in exemplary form the general concept of the present invention. In particular, characteristics contained in the drawings should in no way be deemed a necessary element of the present invention.

They show:

FIG. 1 a schematic representation of an exemplary production installation for producing a building material board and a control device;

FIG. 2 an exemplary flowchart representing a method according to an exemplary embodiment of said aspect of the invention;

FIG. 3 a schematic representation of a grouping of building material board types;

FIG. 4 an exemplary flowchart representing steps of a method according to an exemplary embodiment of said aspect of the invention; and

FIG. 5 a schematic representation of an exemplary embodiment of a device according to the said aspect of the invention, for example a mobile device.

### DESCRIPTION OF THE INVENTION

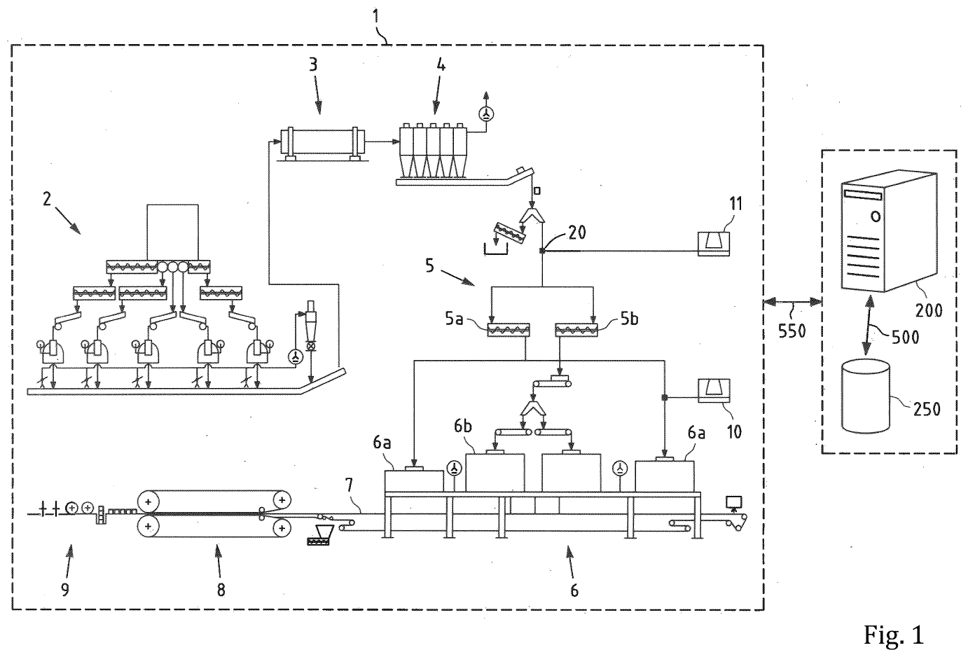

FIG. 1 shows a schematic representation of an exemplary production installation 1 for producing a material board from chipboard as an illustrative example of a building material board in accordance with the present disclosure. FIG. 1 further shows a schematic representation of a control device 200, which is connected to the production installation 1 for controlling the production installation 1 for example via the schematically represented connection 550. For this purpose, the control device 200 can be configured to perform the steps of the method according to the said aspect of the invention. For this purpose, the control device 200 can for example comprise a processing plant such as a computer and/or a computer system connected to (not shown) sensors and/or measuring devices of the production installation 1, for example to obtain from such sensors and/or measuring devices target and/or actual values of process parameters of sections or units of the production installation 1. Alternatively or additionally, the control device 200 in exemplary embodiments may comprise one or more mobile devices, for example one or more smartphones, one or more tablet computers, and/or one or more laptops.

In exemplary embodiments, the control device 200 comprises one or more display devices, such as for example one or more screens, and/or is connected to one or more display devices in order for example to display an indication of the at least one quality characteristic, for example of a building material board in production.

In exemplary embodiments, the control device 200 may comprise a plurality of control devices of which a single control device can perform one or more steps of the method according to the said aspect of the present invention. For example, it may be possible that the control device 200 only schematically represented in FIG. 1 comprises a processing unit such as for example one or more computers which is connected to sensors and/or measuring devices of the production installation 1 (wireless, wired, and/or via an Internet connection), and for example a mobile device connected at least to the processing unit (wireless, wired, and/or via an Internet connection). Thus, it may be possible, for example, that in particular steps comprising displaying and/or inputting data and/or information comprise, in exemplary embodiments, displaying and/or inputting data using (for example, a touchscreen) a mobile device such as a smartphone.

FIG. 1 further shows a storage device (for example one or more hard disks and/or one or more cloud storage units), which can for example be provided for storing sample data records and/or training data records and is connected to the control device 200 via the schematically represented connection 500 for this purpose.

In exemplary embodiments, connections in accordance with the present disclosure, in particular the schematically represented connections 550 between the control device 200 and the production installation 1 (for example, between the control device 200 and one or more sensors, measuring devices and/or control controllers of the production installation 1 and 500 comprise in particular direct or indirect wired communication connections (for example, LAN connections), and/or direct or indirect wireless communication connections comprising radio connections such as Bluetooth, NFC, WLAN, 4G or 5G and/or communication connections over the Internet.

FIG. 1 shows a diagram with units, sections or aggregates of production installation 1 that can be used in the production of the building material boards. In particular, the following sections of the production installation 1 are shown, which can be used for individual production steps for producing a building material board: a chipping machine 2, a dryer for chips 3, a viewing device 4, a device for supplying the chips with a binding agent with mixer 5a, 5b, which also represent other devices, with which binders are applied to the chips, furthermore spreading devices 6 which, if necessary, sprinkle in several layers of different chip sizes from several spreading heads 6a, 6b onto a moulded port belt 7 to form a mat, a continuous press 8 and a cutting or milling device 9 for dimensioning the finished building material boards.

The chipping machines 2 also symbolically represent in general the shredding of wood into chips. The figure shows an example of five knife ring chipping machines fed from a bunker above via screw conveyors.

These can produce different chip sizes depending on the blade setting. The produced chips of different sizes and moisture are forwarded to dryer 3.

The viewing device 4 in the figure below can be used in different versions at different producing points. This device can be used to separate fine particles (e.g. dust) or coarse particles (e.g. undesirable minerals or glue lumps) from the flow of chips. Viewing devices 4 can also be used, for example, to already achieve fractionation according to the chip size during scattering, so that different layers of the subsequent building material board can be generated from chips of different sizes.

In the exemplary embodiment according to FIG. 1 two different chip size ranges are generated, which are fed from bunkers to a mixer 5a and a mixer 5b respectively. In these mixers, the chips are at least partially wetted with binding agent.

Thus, it is possible to supply the spreading heads 6a for the top layers of the mat to be spread and pressed with different chip sizes than the spreading heads 6b for the middle layer(s).

The double belt press 8, as used for the production of building material boards, in particular building material boards made of wood materials, has in its basic structure a press upper part with an upper heatable pressure board and a press lower part with a lower heatable pressure board. Frames in which pressure transducers are also supported for pressure generation connect the upper and lower part of the press. In the upper part of the press and in the lower part of the press, endlessly circumferential steel belts are guided around belt deflection drums to form a press gap for applying pressure and temperature to the mat.

Furthermore, FIG. 1 also recognises a chip size measuring device 10 (an example of a measuring device) downstream of the mixer 5. Optionally, a chip size measuring device 11 can also be provided upstream of the mixer. In this chip size measuring device 10, 11, a representative selection of chips, for example a very small amount of chips discharged from the transport process at a sampling point 20, can be measured. Example process parameters that can be related to such chips measured by the chip size measuring device are for example a feed quantity of binder via glue nozzles, a feed quantity of chips, and/or a transfer speed of chips through the mixer 5a, 5b, a speed of a shaft of a mixer 5a, 5b, etc.

A method according to the said aspect of the present disclosure can be in connection with a production installation according to FIG. 1 wherein it is understood that the present invention does not apply to the production installation according to FIG. 1 is restricted.

According to exemplary embodiments, process parameters can in particular be process parameters of wood material production, for example process parameters of a defibration and glueing section of a production installation for producing wood fibre boards, in particular comprising one or more process parameters selected from at least:
Residual water quantity;
Steam addition cooker;
Cooker fill level;
Cooker temperature;
Cooker steam pressure;
Cooking time;
Quantity of wood chips;
Paraffin addition;
Refiner energy absorption;
Refiner temperature;
Refiner vapour pressure;
Refiner grinding gap;
Grinding disc age;
Blow-off valve opening;
pH of the fibres;
Glue quantity.

In exemplary embodiments, process parameters of a mat forming section of a production installation for producing wood-based panels may comprise, in particular, one or more process parameters selected from at least:
Fibre output quantity;
Spreading height;
Mould belt speed;
Area weight of mat;
Mat moisture;
Spreading width;
Pre-press pressures;
Pre-press distances;
Trim width
Mat density;
Spray water quantity;
Mat height at end of moulding belt;
Mat temperature;
Spraying height;
Misfilling.

Corresponding sensors and/or measuring devices can be provided in a production installation for such process parameters so that target values or actual values set according to these process parameters can be made available to the at least one control device via corresponding communication connections.

In particular, it is possible that, for example, measured and/or set target and/or actual values are stored together with corresponding timestamps during the production of a building material board so that the corresponding process parameter values are available for a produced building material board at the respective times. As described, measurement values for quality characteristics can also be obtained for building material board samples that are rejected for measurement in the laboratory, for example, which can be stored together with the process parameter values in a sample data record or a training data record for the corresponding building material board sample.

According to exemplary embodiments, quality characteristics that can characterise a building material board, in particular one or more quality characteristics, are selected from at least:
Transverse tensile strength;
Raw density;
Bending strength;
Thickening.

Thus, a sample data record or a training data record for a building material board sample in exemplary embodiments comprises data (process parameter data) that represent at least one value (e.g. target and/or actual value) for at least one corresponding process parameter with associated timestamp, and data (quality parameter data) that represent at least one value (e.g. measured value and/or laboratory measured value) for at least one corresponding quality characteristic of a building material board sample.

FIG. 1 further shows a storage medium 250, which is connected to the control device 200 via connection 500, which the control device can thus access.

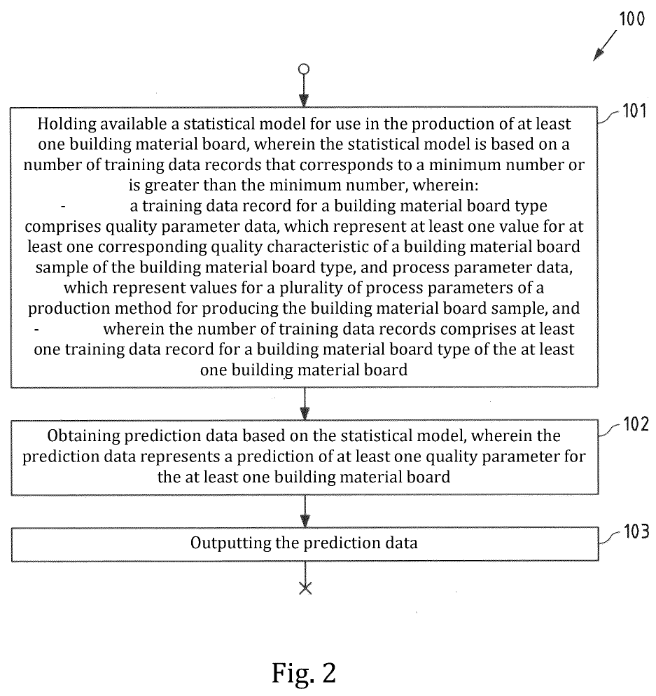

FIG. 2 is an exemplary flowchart representing an exemplary embodiment of the method 100 according to said aspect of the present invention. As an illustration of an exemplary control process for controlling a production installation for producing a building material board, for example the production installation 1 according to FIG. 1 must be understood. Without limiting the invention thereto, it is assumed below that the method 100 is operated by the control device 200 according to FIG. 1. However, method 100 can be executed in other exemplary embodiments by one or more processors of the control device 200, and/or by a plurality of control devices, wherein for example one or more processors and/or one or more of the control devices can perform one or more steps of the method 100.

As shown in FIG. 2, the method 100 comprises a step 101 of holding available a mathematical model for use in the production of at least one building material board, wherein the mathematical model is based on a number of training data records that corresponds to a minimum number or is greater than the minimum number. In other words, the method 100, as described herein, may comprise a step of for example storing the mathematical model (for example of model coefficients for one or more mathematical equations, of training data records for training and/or generating the mathematical model, and/or of data, for example of program data representing the mathematical equations).

As shown, a training data record for a building material board type comprises quality parameter data, which represent at least one value for at least one corresponding quality characteristic of a building material board sample of the building material board type, and process parameter data, which represent values for a plurality of process parameters of a production method for producing the building material board sample.

As shown further, the number of training data records comprises at least one training data record for a building material board type of the at least one building material board. As described herein, the number of training data records in exemplary embodiments may comprise only training data records for the building material board type of the at least one building material board (the building material board that is produced and/or the part of the series of building material boards that are produced). In exemplary embodiments, the number of training data records may comprise the at least one training data record for the building material board type of the at least one building material board (the building material board that is produced and/or the part of the series of building material boards that are produced), and at least one training data record for at least one other building material board type. In this case, in an exemplary embodiment, the mathematical model can be based on a number of training data records for the building material board type of the at least one building material board, and at least on a number of training data records for the other building material board type, wherein the number of training data records for the building material board type of the at least one building material board is less than the minimum number and/or less than the number of building material boards of the other building material board type.

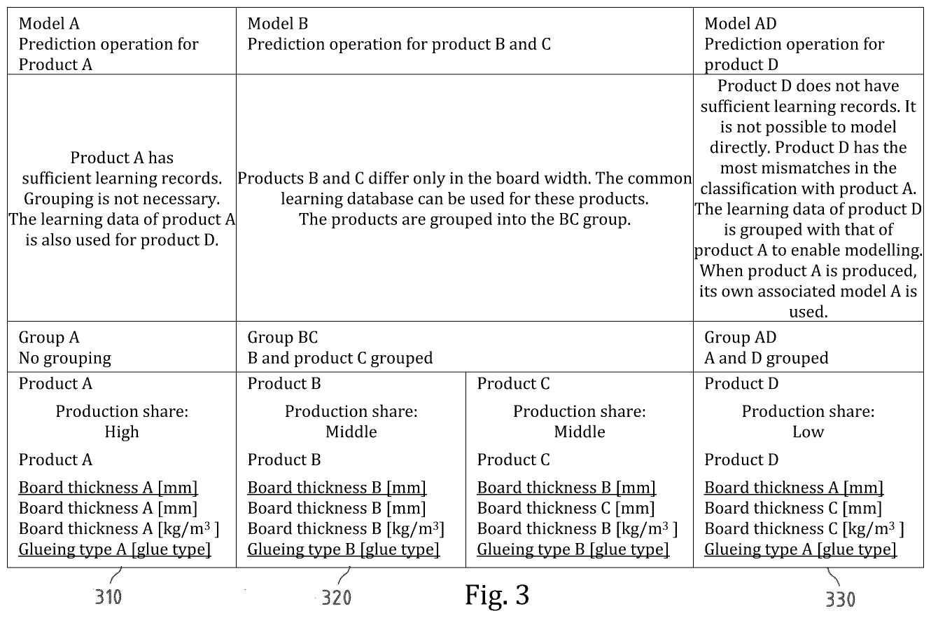

This is shown as an example in FIG. 3 for four different board types A, B, C and D. The box 310 in FIG. 3 illustrates a case in which building material board type A corresponds to at least one building material board (the building material board that is produced and/or is part of the series of building material boards that are produced). As shown, sufficient training data records are available for this board type A, so that a mathematical model for use in the production of building material boards of building material board type A can be generated solely based on training data records for building material board type A.

Box 330 illustrates, by way of example, a case in which the number of training data records for the building material board type of the at least one building material board (the building material board that is produced and/or the part of the series of building material boards that are produced), in the case shown for the building material board type D, is less than the minimum number and less than the number of building material boards of the other building material board type, in the case shown for the building material board type D. However, since properties of building material boards of building material board types A and D match in the example case in the properties board thickness and glueing type, in this case, however, a grouping of building material board types A and D enables a mathematical model to be generated based on training data records for building material board type A and based on training data records for building material board type D, and can be used to predict quality characteristics of board type D even though insufficient sample data records have been generated for this board type alone. Using the described updating processes, the mathematical model based on the grouping of training data records for the building material board type D can be updated successively with training data records for the building material board type D until grouping is also no longer required for the building material board type D.

The grouping of building material board type A and building material board type D shown is advantageous for building material board types D, for which only very few training data records are available, and is possible, since sufficient training data records are available for building material board type A alone. Box 320 of FIG. 3, on the other hand, shows a case of a grouping of building material board types B and C, for which there are not sufficient training data records alone. However, it is still possible to group these building material board types B and C, as the sum of the numbers of training data records available for the individual building material board types B and C is greater than the minimum number.

Again with reference to FIG. 2 method 100 comprises, as shown, a step of obtaining prediction data based on the mathematical model, wherein the prediction data represents a prediction of at least one quality parameter for which at least one building material board (the building material board that is produced and/or is part of the series of building material boards that are produced). As further described herein and as further shown in FIG. 2, the method further comprises a step 103 of outputting the prediction data.

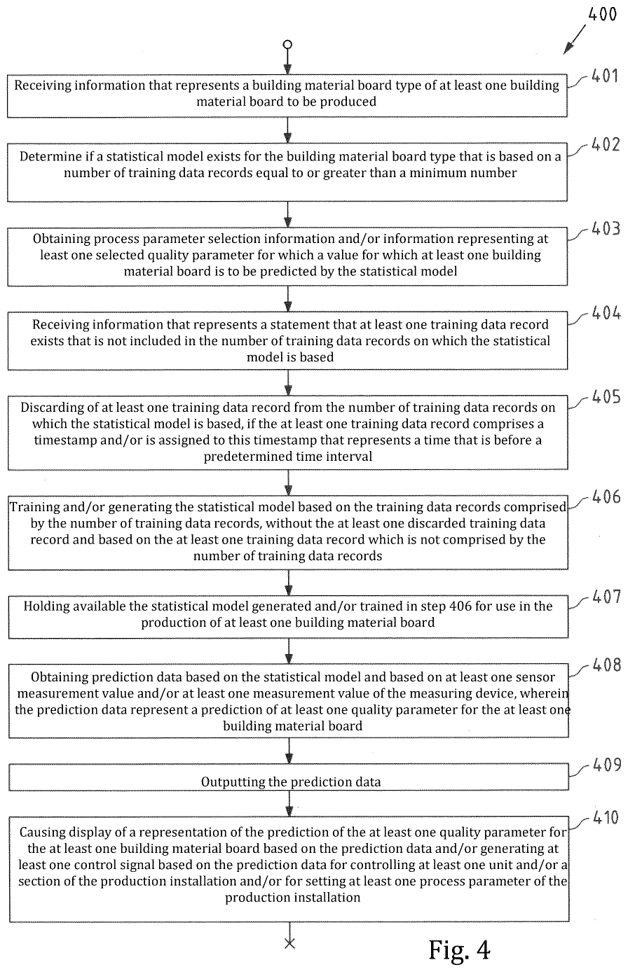

FIG. 4 shows an example flowchart 400, which shows steps of a method according to an example embodiment of the said aspect of the invention. Flowchart 400 can be understood as an illustration of an exemplary control process for controlling a production installation for producing a building material board, for example the production installation 1 according to FIG. 1. Without limiting the invention thereto, it is assumed below that the method 400 is operated by the control device 200 according to FIG. 1. However, method 400 can be executed in other exemplary embodiments by one or more processors of the control device 200, and/or by a plurality of control devices, wherein for example one or more processors and/or one or more of the control devices can perform one or more steps of the method 400.

As shown, the method 400 comprises a step 401 of obtaining information representing a building material board type of the at least one building material board to be produced.

This step can, for example, be carried out in connection with a production change when a building material board type to be produced is changed. The information regarding the building material board type can be provided, for example, based on an input of an operator of the production installation via the said user interface.

As shown further, based on this, the control device 200 determines whether a mathematical model for the building material board type exists based on a number of training data records equal to or greater than the minimum number. In other words, the control device 200 checks in step 402 whether there is a mathematical model for the building material board type received in step 401 (for example, set by an operator of the production installation) for which sufficient training data records exist alone or for the one grouped with another building material board type.

In a step 403, the control device 200 receives process parameter selection information and/or information representing at least one selected quality parameter for which a value for which at least one building material board is to be predicted by the mathematical model. As described, the control device 200 can receive the process parameter selection information and/or the information regarding the selected quality parameter in particular based on a user input.

The control device 200 can now generate the mathematical model based on the selection of process parameters and/or for the at least one selected quality parameter. As in FIG. 4, the method in the example shown comprises a step 404 of obtaining information that represents a statement that at least one training data record exists that is not comprised by the number of training data records on which the mathematical model is based.

This step can be performed directly after step 402. For example, during a production change with step 402, it can be determined that a mathematical model has already been used for the building material board type to be produced, for example in a previous production cycle. The corresponding mathematical model (for example corresponding model coefficients, training data records and/or data representing corresponding equations) may have been stored accordingly for further use after completion of the previous production cycle.

In step 404, it can now be determined that in the meantime more sample data records were received as training data records, for example from a laboratory in which corresponding board samples were examined in the meantime, which were not yet available for the last model used. However, step 404 can also be carried out (additionally or alternatively) during a production process of producing the at least one building material board if, for example, further sample data records become available as training data records during the production process.

In a step 405, the control device discards at least one training data record from the number of training data records on which the mathematical model is based if the at least one training data record comprises a timestamp and/or is assigned to this timestamp that represents a time, which lies before a predetermined time interval (for example, before a time interval prior to the start of an execution of the method and/or a production of the at least one building material board). This step 405 can be executed directly after step 402 (before and/or after step 404). As described herein, the control device 200 can, for example, be configured to receive information that represents a statement that at least one training data record on which the mathematical model is based (for example, the mathematical model, that was used in the previous production cycle) includes or is associated with a timestamp that represents a time before a predetermined time interval. This information can be received by the control device 200 for example based on an input via said user interface. Alternatively or additionally, the control device 200 may be configured, for example to automatically determine after step 402 whether at least one training data record on which the mathematical model is based comprises or is associated with a timestamp that represents a time that is prior to a predetermined time interval. However, step 405 can also be carried out at another time, for example during or after the production process for producing the at least one building material board.

As in FIG. 4, the method 400 further comprises a step 406 of training and/or generating the mathematical model based on the training data records comprised by the number of training data records (the number of training data records according to step 402, without the at least one training data record discarded (in step 405) and based on the at least one training data record (according to step 404) which is not comprised by the number of training data records. In other words, steps 404 and 405 represent update steps in which newly available and too old training data records are determined. In step 406, the mathematical model is generated/trained based on the non-discarded training data records (which were already available) and the newly available training data records.

In a step 407, the control device 200 holds the mathematical model generated and/or trained in step 406 for use in the production of the at least one building material board. The control device can store the mathematical model generated in step 406 (corresponding model coefficients, corresponding training data records and/or data representing corresponding mathematical equations) for example on the storage medium 250 for use in the production of the at least one building material board.

In a step 408, the control device 200 receives (e.g. calculated) prediction data based on the mathematical model and based on at least one sensor measurement value of a sensor of the production installation 1 and/or at least one measurement value of the said measuring device of the production installation 1, wherein the prediction data represent a prediction of at least one quality parameter for the at least one building material board. The prediction data is output in step 409. As mentioned, the output prediction data can for example be converted by the control device 200 into the said control signals and/or into the said display data, which can be used by the said display device (e.g. from a screen connected to the control device) to display a representation or representation.

Thus, the method 400 comprises a step 410 of causing a display of a representation of the prediction of the at least one quality parameter for the at least one building material board based on the prediction data and/or generating at least one control signal based on the prediction data for controlling at least one unit and/or a section of the production installation 1 and/or for setting at least one process parameter of the production installation 1.

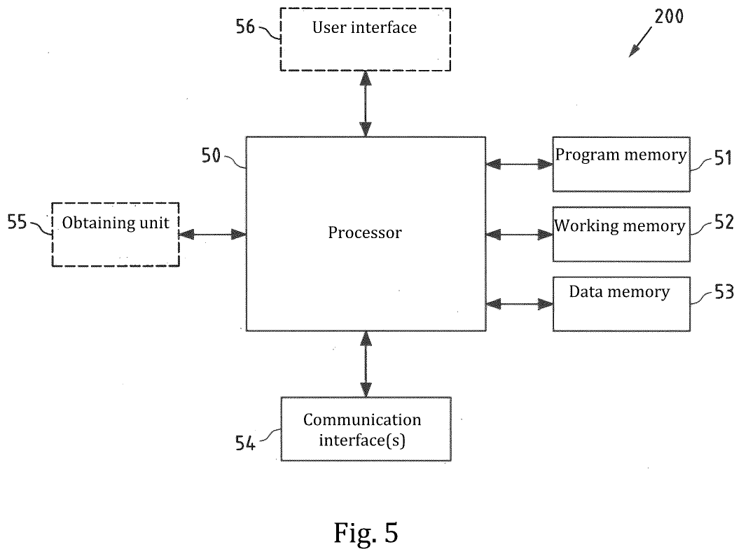

FIG. 5 is a schematic representation of an exemplary embodiment of a control device 200 configured to perform the method according to the said aspect of the invention. The control device 200 can for example be at least part of a control device of a production installation.

The control device 200 comprises a processor 50, a program memory 51, a working memory 52, a useful data memory 200, one or more communication interface(s) 54, a recording unit 55 for example for recording actual or target values for one or more process parameters and a user interface 56.

For example, the processor 50 executes a program for performing the said method according to the said aspect of the invention, which is stored in the program memory 51.

The working memory 52 is used in particular for storing temporary data during the execution of this program.

The useful data memory 250 serves to store data required for processing the program and can correspond to the storage medium 250 of FIG. 1.

The communication interface(s) 54 comprise one or more interfaces for communicating the device in particular with the production installation 1 and/or at least with parts (for example, with one or more sensors and/or with one or more measuring devices) of the production installation 1. The interface can be based on a wired and/or wireless (e.g. on cellular mobile communications (e.g. GSM, E-GSM, UMTS, LTE, 5G) or on WLAN (Wireless Local Area Network).

The user interface 56 may be configured as a screen and keyboard and/or as a touch-sensitive display (touchscreen). The user interface 56 can be connected directly (for example, wired) to the processor 50 and/or the control device 200, and/or (several user interfaces 56 may be provided) can be connected via a wired and/or wireless (e.g. communication connection based on GSM, E-GSM, UMTS, LTE, 5G and/or WLAN (Wireless Local Area Network) technology, for example an Internet connection comprising communication connection, to the processor 50 and/or the control device 200. In the latter case, a remote connection to the control device 200 can thus be enabled, which for example allows a user to remotely access the control device 200 and thus possibly operate several control devices 200.

The following exemplary embodiments are also part of the present disclosure:

### Embodiment 1

A method (100), for example performed by at least one device (200) or a system comprising at least two devices (200), wherein the method (100) comprises:
Holding available (101) a mathematical model for use in the production of at least one building material board, wherein the mathematical model is based on a number of training data records that corresponds to a minimum number or is greater than the minimum number;
wherein a training data record for a building material board type comprises quality parameter data representing at least one value for at least one corresponding quality characteristic of a building material board sample of the building material board type, and process parameter data representing values for a plurality of process parameters of a production method for producing the building material board sample;
wherein the number of training data records comprises at least one training data record for a building material board type of the at least one building material board, the method further comprising:
Obtaining (102) prediction data based on the mathematical model, wherein the prediction data represents a prediction of at least one quality parameter for the at least one building material board;
Outputting (103) the prediction data.

### Embodiment 2

The method (100) according to embodiment 1, wherein the number of training data records comprises the at least one training data record for the building material board type of the at least one building material board, and at least one training data record for at least one other building material board type.

### Embodiment 3

The method (100) according to embodiment 2, wherein a production share of a total production quantity of building material boards of the building material board type of the at least one building material board is approximately equal to or less than a production share of building material boards of the other building material board type.

### Embodiment 4

The method (100) according to one of embodiments 2 or 3, wherein the mathematical model is based on a number of training data records for the building material board type of the at least one building material board, and at least a number of training data records for the other building material board type, wherein the number of training data records for the building material board type of the at least one building material board is less than the minimum number and/or less than the number of building material boards of the other building material board type.

### Embodiment 5

The method (100) according to one of embodiments 2 to 4, wherein for the building material board type of the at least one building material board and for the at least one other building material board type a value of a difference between at least one parameter value characterising a property of the building material board type of the at least one building material board, and at least one corresponding parameter value characterising the corresponding property of the at least one other building material board type, equals or falls below a maximum value.

### Embodiment 6

The method (100) according to one of embodiments 1 to 5, wherein a property of a building material board type is selected from at least:
Building material board thickness;
Building material board width;
Building material board density;
Type of bonding of the building material board;
At least one material of the building material board, in particular at least one type of glue and/or one type of wood material.

### Embodiment 7

The method (100) according to one of embodiments 1 to 6, wherein the minimum number of training data records is between 20 and 100, between 30 and 80, between 35 and 70, and/or between 40 and 60, for the one or more quality parameters, for which prediction data are obtained based on the mathematical model.

### Embodiment 8

The method (100) according to one of embodiments 1 to 7, further comprising:
Obtaining information representing the building material board type of the at least one building material board;
Determining, based on the information received representing the building material board type of the at least one building material board, whether a mathematical model for use in producing the at least one building material board is available based on a number of training data records equal to or greater than the minimum number; and
Holding available the mathematical model for use in the production of the at least one building material board if it is determined that the mathematical model is available for use in the production of the at least one building material board.

### Embodiment 9

The method (100) according to one of embodiments 1 to 8, further comprising:
Training and/or generating the mathematical model for use in the production of at least one building material board based on the number of training data records that corresponds to or is greater than the minimum number.

### Embodiment 10

The method (100) according to one of embodiments 1 to 9, wherein a training data record further comprises a timestamp and/or there is an association between the timestamp and the training data record, wherein the timestamp represents a time at which the building material board sample was produced, the method (100) further comprising:
Discarding at least one training data record from the number of training data records on which the mathematical model is based, if the at least one training data record comprises a timestamp and/or is assigned to this timestamp that represents a time that is before a predetermined time interval;
Training and/or generating the mathematical model for use in producing the at least one building material board based on a number of training data records that does not contain the at least one discarded training data record.

### Embodiment 11

The method (100) according to one of embodiments 1 to 10, further comprising:
Receiving information that represents a statement that at least one training data record exists that is not included in the number of training data records on which the mathematical model is based;
Training and/or generating the mathematical model based on the training data records comprised by the number of training data records and based on the at least one training data record not comprised by the number of training data records.

### Embodiment 12

The method (100) according to any one of embodiments 1 to 11, wherein holding available the mathematical model for use in producing the building material board comprises:
Obtaining process parameter selection information representing a selection of process parameters of the production method for producing the at least one building material board and/or information representing at least one selected quality parameter for which a value for which at least one building material board is to be predicted by the mathematical model;
Training and/or generating the mathematical model based on the selection of process parameters and/or for the at least one selected quality parameter.

### Embodiment 13

The method (100) according to one of embodiments 1 to 12, wherein the method (100) is carried out by at least one control device (100) of a production installation 1 for producing building material boards or by a system comprising such a control device (200), wherein the production installation 1 has output at least one sensor and/or a measuring device that is configured with at least one sensor measurement value and/or a measurement value of the measuring device as a target or actual value of a corresponding process parameter characterising a corresponding process condition during the production of the building material board by the production installation, wherein obtaining the prediction data based on the mathematical model further comprises:
Obtaining the prediction data based on the mathematical model and based on at least one sensor measurement value and/or at least one measurement value of the measuring device.

### Embodiment 14

The method (100) according to one of embodiments 1 to 13, further comprising:
Causing display of a representation of the prediction of the at least one quality parameter for the at least one building material board based on the prediction data; and/or
Generating at least one control signal based on the prediction data for controlling at least one component of the production installation 1 and/or for setting at least one process parameter of the production installation 1 when producing the at least one building material board.

### Embodiment 15

The method (100) according to one of embodiments 1 to 14, wherein the mathematical model comprises a simultaneous equation model, in particular a mathematical model based on the three-stage least squares method, a mathematical model based on two-stage least squares (“2SLS”), a mathematical model based on partial least squares (PLS), and/or a linear regression model.

### Embodiment 16

Device (200) or system consisting of at least two devices (200), configured to perform and/or control the method (100) according to one of embodiments 1-15 or comprising respective means for performing and/or controlling the steps of the method (100) according to one of embodiments 1-15.

### Embodiment 17

Computer program, comprising program instructions that prompt one or more processors to execute and/or control the method (100) according to any one of embodiments 1-15 if the computer program is executed by the processor (50) or the processors (50).

The exemplary embodiments of the present invention described in this specification should also be understood as being disclosed in all combinations with each other. In particular, the description of a characteristic included by an embodiment, provided the opposite is not explicitly explained, should also not be understood in the present case as the characteristic being necessary or essential for the function of the exemplary embodiment. The sequence of the method steps outlined in this specification is not mandatory, alternative sequences of the method steps are conceivable, unless stated otherwise. The method steps can be implemented in a different manner, thus an implementation in software (by program instructions), hardware or a combination of the two in order to implement the method steps is conceivable.

Terms used in the claims such as “comprise”, “have”, “contain”, “include” and the like do not exclude additional elements or steps. The wording “at least partially” includes both the case of “partially” and also the case of “fully”. The wording “and/or” should be understood as both the alternative and the combination being disclosed, i.e. “A and/or B” means “(A) or (B) or (A and B)”. A plurality of units or the like means multiple units or the like in the context of this specification. The use of the indefinite article does not exclude a plurality. An individual apparatus can perform the functions of a plurality of units or apparatuses mentioned in the claims. Reference numerals indicated in the claims should not be considered as limitations of the means and steps used.

1.-16. (canceled)

17. A method for outputting prediction data of a prediction of at least one quality parameter for at least one building material board, the method being carried out by at least one control device of a production plant for producing building material boards,
the production plant having at least one sensor and/or one measuring device which is/are configured to output at least one sensor measurement value and/or one measured value of the measuring device as a setpoint or actual value of a corresponding process parameter which characterizes a corresponding process condition during the manufacture of the building material board by the production plant, the method comprising:
holding available a mathematical model for use in manufacturing at least one building material board, the mathematical model comprising a set of model coefficients for one or more mathematical equations, wherein the one or more mathematical equations can output an expected value for at least one quality parameter based on an input of values from at least one process parameter data set, which comprises values for process parameters with associated timestamp, and wherein the mathematical model is based on a number of training data sets which corresponds to a minimum number or which is greater than this minimum number;
wherein the minimum number corresponds to a number of training data sets for which the mathematical model can output a prediction value for at least one quality parameter when the mathematical model is trained and/or generated based on this number of training data sets, wherein a quality of the prediction value satisfies a predetermined quality criterion;
wherein a training data set for a building material board type comprises quality parameter data representing at least one value for at least one corresponding quality characteristic of a building material board sample of the building material board type, and process parameter data representing values for a plurality of process parameters of a production process for producing the building material board sample;
wherein in the number of training data sets comprises at least one training data set for a building material board type of the at least one building material board, and at least one training data set for at least one other building material board type, the method further comprising:
obtaining prediction data based on the mathematical model and based on the at least one sensor measurement value and/or at least one measured value of the measuring device, the prediction data representing a prediction of at least one quality parameter for the at least one building material board;
wherein obtaining the prediction data comprises:
using the at least one obtained sensor measurement value and/or the at least one obtained measured value of the measuring device as an input variable or as input variables for the mathematical model, and
calculating the prediction data using the mathematical model based on the input variable or variables;
wherein the mathematical model is based on a number of training data sets for the building material board type of the at least one building material board, and on at least a number of training data sets for the building material board type of the at least one building material board is smaller than the minimum number;
wherein a sum of the number of training data sets for the building material board type of the at least one building material board and the number of training data sets for the other building material board type corresponds to a number that is equal to or greater than the minimum number; and the method further comprising:
outputting the prediction data.

18. The method according to claim 17, wherein a production share in a total production quantity of building material boards of the building material board type of the at least one building material board is equal to or less than a production share of building material boards of the other building material board type.

19. The method according to claim 17, wherein the mathematical model is based on a number of training data sets for the building material board type of the at least one building material board, and at least a number of training data sets for the other building material board type, wherein the number of training data sets for the building material board type of the at least one building material board is smaller than the number of building material boards of the other building material board type.

20. The method according to claim 17, wherein, for the building material board type of the at least one building material board and for the at least on other building material board type, a value of a difference between at least one parameter value characterizing a property of the building material board type of the at least one building material board and at least one corresponding parameter value characterizing the corresponding property of the at least one other building material board type is equal to or less than a maximum value.

21. The method according to claim 17, wherein a property of a building material board type is selected at least from:
building material board thickness;
building material board width;
building material board density;
type of gluing of the building material board;
at least one material of the building material board, in particular at least one type of glue and/or one type of wood material.

22. The method according to claim 17, wherein the minimum number of training data sets is between 20 and 100, between 30 and 80, between 35 and 70, or between 40 and 60, for the one or more quality parameters for which prediction data is obtained based on the mathematical model.

23. The method according to claim 17, further comprising:
obtaining information representing the building material board type of the at least one building material board;
determining, based on the obtained information representing the building material board type of the at least one building material board, whether there is a mathematical model for use in manufacturing the at least one building material board based on a number of training data sets equal to or greater than the minimum number.

24. The method according to claim 17, further comprising:
training and/or generating the mathematical model for use in manufacturing at least one building material board based on the number of training data sets equal to or greater than the minimum number.

25. The method according to claim 17, wherein a training data set further comprises a timestamp and/or there is an association between the timestamp and the training data set, wherein the timestamp represents a point in time at which the building material board sample was produced, the method further comprising:
discarding at least one training dataset from the number of training datasets on which the mathematical model is based if the at least one training dataset comprises and/or is associated with a timestamp representing a point in time prior to a predetermined time interval;
training and/or generating the mathematical model for use in manufacturing the at least one building material board based on a number of training data sets which does not include the at least one discarded training data set.

26. The method according to claim 17, further comprising:
obtaining information representing a statement that at least one training data set is present that is not included in the number of training data sets on which the mathematical model is based;
training and/or generating the mathematical model based on the training data sets included in the number of training data sets and based on the at least one training data set not included in the number of training data sets.

27. The method according to claim 17, wherein providing the mathematical model for the use in manufacturing the building material board comprises:
obtaining process parameter selection information representing a selection of process parameters of the production method for manufacturing the at least one building material board and/or information re-representing at least one selected quality parameter for which a value for the at least one building material board is to be predicted by the mathematical model;
training and/or generating the mathematical model based on the selection of process parameters and/or for the at least one selected quality parameter.

28. The method according to claim 17, further comprising:
causing a display of a representation of the prediction of the at least one quality parameter for the at least one building material board based on the prediction data; and/or
generating at least one control signal based on the prediction data for controlling at least one component of the production plant and/or for adjusting at least one process parameter of the production plant during production of the at least one building material board.

29. The method according to claim 17, wherein the mathematical model comprises a simultaneous equation model, in particular a mathematical model based on the three-stage least squares method, a mathematical model based on the two-stage least squares method (“2SLS”), a mathematical model based on the partial least squares (PLS), and/or a linear regression model.

30. A control device for a production plant for manufacturing building material boards, comprising a processor, a program memory, a working memory, a user data memory, one or more communication interfaces, a detection unit for detecting actual or setpoint values for one or more process parameters and a user interface, the control device being set up for carrying out the method according to claim 1.

31. A production plant for producing building material boards, comprising at least one control device according to claim 30, and a sensor and/or a measuring device which is/are configured to output at least one sensor measurement value and/or a measured value of the measuring device as a setpoint or actual value of a corresponding process parameter.

32. The control device having a processor, according to claim 30, further comprising a computer program comprising program instruction that cause the control device to execute said method on the processor.
